(19) United States
(12) Patent Application Publication
(10) Pub. No.: US 2012/0189989 A1
(43) Pub. Date: Jul. 26, 2012

(54) Assisted Leveled Reading System & Method

(75) Inventor: Ann Margaret Mowery, McGregor, TX (US)

(73) Assignee: Ann Margaret Mowery, McGregor, TX (US)

(21) Appl. No.: 13/012,784

(22) Filed: Jan. 24, 2011

(51) Int. Cl. G09B 17/00

(52) U.S. Cl. 434/178

(57) ABSTRACT

This patent relates to a technology assisted program for beginning readers utilizing a web based reading system, voice recognition geared to a beginning reader, leveled text and assessment feedback that includes data on decoding accuracy, fluency rate and degree of comprehension. An additional embodiment of the present invention is a telephone reading system consisting of leveled text and assessment feedback including data on decoding accuracy, fluency rate and degree of comprehension. An additional embodiment of the present invention is a personal computer application reading system, voice recognition geared to a beginning reader, leveled text and assessment feedback that includes data on decoding accuracy, fluency rate and degree of comprehension. An additional embodiment of the present invention is a tablet application reading system, voice recognition geared to a beginning reader, leveled text and assessment feedback that includes data on decoding accuracy, fluency rate and degree of comprehension.

### CROSS REFERENCES TO RELATED PATENT

Not applicable

### TECHNICAL FIELD

This invention relates to a method of reading instruction, specifically to a mechanism for teaching reading through a leveled reading method using interactive feedback through a telephonic device or a computer device.

BACKGROUND ART

In 2000, the National Reading Panel issued a report that identified the critical factors in learning to read for beginning readers. The Panel also identified research-based instructional strategies that consistently related to successful acquisition of reading skills. Identified were five areas of reading instruction: phonemic awareness, phonics, fluency, vocabulary and text comprehension.

Students who struggle with reading are often bogged down with laboriously sounding out every word; with the net result that they never do get the meaning of what they are attempting to read. These students are termed non-fluent readers. Fluency, a critical reading skill, is the ability to read text accurately and quickly. It allows the student to move through the words almost automatically so his/her attention is directed to determining the meaning of the sentences and passages being read. Fluency is tremendously important because it creates a connection between word recognition and text comprehension. The National Reading Panel report noted that fluency “develops gradually over considerable time and through substantial practice.”

Educators have long known that practice is essential for reading development. Reading research has shown that students who engage in reading and re-reading passages of text under the guidance and feedback from a more skilled reader become better readers. In order to accomplish this, the teacher in a typical primary classroom, structures the day so that she has the opportunity to meet with small groups of students in order to hear them practice reading out loud. The issue for the teacher is always time. She is responsible for guiding the reading development of typically 20-30 students and having sufficient time to monitor individual student's reading is problematic.

Schools, therefore, recognizing the need that beginning readers have for reading practice and the inherent limitations of the classroom due to the numbers of beginning readers, traditionally have sought help from the home. It is very common for primary teachers to request that an adult in the home read fifteen minutes per night with the beginning readers. There are many homes where reading in the evening with a beginning reader is a common practice, but each year an increasing number of students go home to environments or situations where there is simply no reading support for them. This may be due to environments where the adults are poorly educated and cannot read themselves or read with extreme difficulty. Parents are then unlikely to want to expose their own deficiency to their beginning readers. It may be a home where the adults are non-English speaking and illiterate in English. There are situations where a single parent working multiple jobs or very long hours to support a family is just too exhausted to take the time in the evening to read with the youngster. Middle class income homes are not immune to the situation either. Upwardly mobile parents, immersed in their careers, while well educated, may not spare the time to sit with the beginning readers in order to practice reading.

The net result is that beginning readers from homes where they receive guided practice with reading on a regular basis have a leg up from their peers who do not have similar support. These beginning readers are exposed to many more books and all that practice contributes to a high fluency rate and increased reading achievement as compared to the less fortunate peers. The dreaded “achievement gap” is established early and it is very much due to environmental factors.

Research has also shown that students should practice orally re-reading text that is fairly easy for them. In other words, text in which approximately 90% of the words are easy for them to decode. Until the 90s, most beginning reader's books used for instruction were the “graded” variety. That is, a beginning reader might see 4-5 reading texts in the course of a year of instruction. In the early 90s another approach emerged which utilized a “leveled reader” methodology. Originated in New Zealand, books were written in much smaller incremental levels of difficulty. The difficulty of the leveled readers was dependent on formulas that took into consideration such factors as high frequency words, number of syllables in the words and length of the sentences, for example. A number of leveling systems have been developed and books utilizing the leveled approach are used quite extensively today in beginning reading instruction. Utilization of these leveled books has proven to be a useful instructional tool to carefully scaffold a beginning reader through his/her early reading development.

Development of the leveled readers emerged as one of the critical elements in the design of structured remedial approaches to assisting struggling readers. Certainly one of the more acclaimed remedial programs was Marie Clay's Reading Recovery approach that began in New Zealand in the 1976. Other remedial programs have sprung from Clay's concepts and generally incorporate the utilization of leveled readers and what is referred to as “repeated reading.”

By “repeated readings”, it is meant that the reader should read and re-read text that is familiar to them. Research has shown the value of repeated reading rests in acquiring familiarity with the words as a total unit, rather than a summation of individual phonemes. The facility that develops to immediately recognize words through repeated exposure to them significantly impacts fluency. It has been shown that re-reading familiar text three to four times is an excellent strategy that strongly impacts fluency.

A beginning or struggling reader also needs feedback. The role that the more skilled reader (generally an adult) plays in the beginning reader's reading development is to listen to his/her oral reading and assist with corrective feedback.

Scientifically based research regarding fluency has shown that: students must spend time practicing reading; students should practice orally reading text that is relatively easy for them; students gain fluency from re-reading familiar text and corrective feedback is a necessary component of oral reading practice.

Successful remedial programs that are designed to increase a student's fluency level have incorporated the elements listed above. Leveled readers are utilized so that a beginning readers is moved in very small steps through more challenging text. Typically, a struggling first grader will gradually develop fluency through approximately 15-17 levels of difficulty of text.

In addition, these programs measure and document a beginning reader's reading progress by determining his/her fluency rate and the accuracy of word call. Also, asking generally literal questions about the reading often checks comprehension of the text.

The issue for most schools is manpower. To achieve the greatest gains in reading achievement, each beginning reader should orally read 1:1 with an adult so that corrective feedback is individualized. Although optimal, it is fiscally unrealistic for most schools today. There are some that are fortunate enough to be able to implement a Reading Recovery program that does provide the 1:1 ideal situation and there are others that employ remedial reading teachers to work with small groups of beginning readers throughout the day. However, most schools have to rely on the classroom teacher to handle remediation. Providing reading instruction for a classroom of beginning readers plus additional intensive work with small groups of struggling readers leaves little time to listen to students' oral reading and provide corrective feedback. The challenge for schools is to find a way to provide the necessary practice for beginning readers within the personnel limitations that budgets impose on the schools.

U.S. Pat. No. 6,017,219 refers to a “computer-based” reading system. In contrast, the present invention disclosed herein is a web-based reading system. Moreover, U.S. Pat. No. 6,017,219 references “lessons”. In contrast, the present invention disclosed herein is not “lessons” based. There is no teaching of reading. This patent application discloses a method using stories in a leveled progression for the students to practice reading with. It is the structure of those “stories” that is the critical piece in our disclosure. The text which beginning readers are introduced to is extremely important for reading development. Educators have known that children learn to read with materials that are not too difficult. Determining the level of difficulty prior to the 1990s was done with readability formulas and provided a score that ranked books into fairly general categories of grade level difficulty. Leveled readers are utilized today as the primary reading instruction method. This approach was developed in New Zealand through the work of Marie Clay (1991) and the Reading Recovery program that was directed to early reading intervention tutoring for children experiencing difficulties in beginning reading. While the older reading programs (1920s-80s) normally had four books of increasing difficulty for first grade readers, the leveled reading program for a student in the first year of reading instruction has typically 15 levels of difficulty, a closely spaced sequence of texts whose leveled designation depends on such factors as number of pages, words in a sentence, repetition, use of high-frequency words, text with regular spelling words, and content words reinforced by pictures and repetition. The use of stories using leveled text is a critical differential between this web-based reading program and U.S. Pat. No. 6,017,219. Finally, U.S. Pat. No. 6,017,219 references “Monitoring Student Progress.” The present invention referenced herein incorporates a testing mode which provides the teacher with the level read, percent accuracy of decoding, fluency rate, miscue analysis and a comparison to the grade level standard in accuracy and fluency. In other words, when the report is generated, it will compare the student's performance at that time in the school year to that of a student who is considered to be at grade level standard at that same point in the school year.

To date, there is no prior art that allows a reading fluency program that has assisted instruction using a telephonic device or web based program. Moreover, there is no prior art that allows for a level reading program using voice recognition for feedback so as to minimize human corrective feedback, and thus provide for a 1:1 ideal situation.

### DISCLOSURE OF INVENTION

These and other problems are generally solved or circumvented, and technical advantages are generally achieved, by preferred embodiments of the present invention that provides for method of reading instruction, specifically to a mechanism for teaching reading through a leveled reading method using interactive feedback through a telephonic device or a computer device.

Research has shown that reading achievement is strongly affected by fluency; however, in order for a reader to become fluent, s/he must have extensive practice with corrective feedback. The teacher, due to the numbers of students in a classroom does not have the time to listen and provide the necessary feedback to an emergent reader and often depends on the home to fill that gap. For a variety of reasons, the family members in the home are unable to listen to the student read.

The presently preferred embodiment of the present invention utilizes trained, literate adults to listen to beginning readers and provide corrective feedback via a telephone subscription. The second part of the presently preferred embodiment of the present invention is high interest, appropriate leveled text so that the student can move through highly structured reading materials designed to slowly increase the level of difficulty of the reading. The third part of the presently preferred embodiment of the present intention is a detailed student progress report which includes specific information regarding the student's reading ability; namely, level of reading difficulty, accuracy of decoding and fluency rate.

Accordingly, besides the objects and advantages of an assisted leveled reading method described in the above patent, an additional object and advantage of the preferred embodiment of the present invention is to provide the emergent reader access to a trained, literate adult who can listen and provide corrective feedback to the student.

Another object and advantage of the preferred embodiment of the present invention is to provide high interest, developmentally appropriate leveled texts.

Another object and advantage of the preferred embodiment of the present invention is to provide to the parent/teacher/adult a periodic detailed reading progress report that relates level of reading text, accuracy of decoding and fluency rate.

Still further objects and advantages will become apparent from a consideration of the ensuing description and drawings. Similar constructions that do not depart from the spirit and scope of this invention set forth in the claims or embodiment should be considered the equivalent.

An additional embodiment of the present invention is to provide a web-based reading program by utilizing a web based server that contains the application and can be accessed through a subscription. The second part of the additional embodiment is high interest, appropriate leveled text so that the student can move through highly structured reading materials designed to slowly increase the level of difficulty of the reading by means of the computer screen. The third part of the additional embodiment is voice recognition software that can interpret the student's reading vocalizations and provide corrective feedback. The fourth part of the additional embodiment of the present invention is a detailed student progress report which includes specific information regarding the student's reading ability; namely, level of reading difficulty, accuracy of decoding and fluency rate and can be accessed through the computer reading program.

Accordingly, besides the objects and advantages of an assisted leveled reading method described in the above patent, an additional object and advantage of the additional embodiment of the present invention is to provide the emergent reader the opportunity to practice reading and receive corrective feedback through the use of a computer, which does not necessitate utilizing human personnel.

Another object and advantage of the additional embodiment of the present invention is to provide high interest, developmentally appropriate leveled texts through a web-based reading program.

Another object and advantage of the additional embodiment of the present invention is to provide to the parent/teacher/adult/student a periodic detailed reading progress report that relates level of reading text, accuracy of decoding and fluency rate through a web-based reading program.

Still further objects and advantages will become apparent from a consideration of the ensuing description and drawings. Similar constructions that do not depart from the spirit and scope of this invention set forth in the claims or embodiment should be considered the equivalent.

An additional embodiment of the present invention is to provide a reading program using an application designed for the Apple iPad, iTouch, or iPhone using this assisted leveled reading method. The second part of the additional embodiment of the present invention is high interest, appropriate leveled text so that the student can move through highly structured reading materials designed to slowly increase the level of difficulty of the reading by means of the computer screen. The third part of the additional embodiment of the present invention is voice recognition software that can interpret the student's reading vocalizations and provide corrective feedback. The fourth part of the additional embodiment of the present intention is a detailed student progress report which includes specific information regarding the student's reading ability; namely, level of reading difficulty, accuracy of decoding and fluency rate and can be accessed through the computer reading program.

Accordingly, besides the objects and advantages of an assisted leveled reading method described in the above patent, an additional object and advantage of the additional embodiment of the present invention is to provide the emergent reader the opportunity to practice reading and receive corrective feedback through the use of a iPad, iTouch, or iPhone, which does not necessitate utilizing human personnel.

Another object and advantage of the additional embodiment of the present invention is to provide the emergent reader with a highly mobile wireless platform that the student can carry and hold in his/her hands. It allows him/her to practice reading in multiple locations within the classroom, school and home.

Another object and advantage of the additional embodiment of the present invention is the ability to download the application and content from the Apple online store. This makes a subscription download extremely easy for the parent or teacher.

Another object and advantage of the additional embodiment of the present invention is to provide high interest, developmentally appropriate leveled texts using the Apple product.

Another object and advantage of the additional embodiment of the present invention is to provide to the parent/teacher/adult/student a periodic detailed reading progress report that relates level of reading text, accuracy of decoding and fluency rate using the Apple product.

Still further objects and advantages will become apparent from a consideration of the ensuing description and drawings. Similar constructions that do not depart from the spirit and scope of this invention set forth in the claims or embodiment should be considered the equivalent.

An additional embodiment of the present invention is to provide a reading program utilizing an application designed for a Tablet computer containing the reading program. The second part of the additional embodiment of the present invention is high interest, appropriate leveled text so that the student can move through highly structured reading materials designed to slowly increase the level of difficulty of the reading by means of the computer screen. The third part of the additional embodiment of the present invention is voice recognition software that can interpret the student's reading vocalizations and provide corrective feedback. The fourth part of the additional embodiment of the present invention is a detailed student progress report which includes specific information regarding the student's reading ability; namely, level of reading difficulty, accuracy of decoding and fluency rate and can be accessed through the computer reading program.

Accordingly, besides the objects and advantages of an assisted leveled reading method described in the above patent, an additional object and advantage of the additional embodiment of the present invention is to provide the emergent reader with a highly mobile wireless platform which the student can carry and hold in his/her hands. It allows him/her to practice reading in multiple locations within the classroom, school and home.

Another object and advantage of the additional embodiment of the present invention is to provide high interest, developmentally appropriate leveled texts using a tablet personal computer.

Another object and advantage of the additional embodiment of the present invention is to provide to the parent/teacher/adult/student a periodic detailed reading progress report that relates level of reading text, accuracy of decoding and fluency rate using a tablet personal computer.

Still further objects and advantages will become apparent from a consideration of the ensuing description and drawings. Similar constructions that do not depart from the spirit and scope of this invention set forth in the claims or embodiment should be considered the equivalent.

### BRIEF DESCRIPTION OF DRAWINGS

For a more complete understanding of the present invention, and the advantages thereof, reference is now made to the following descriptions taken in conjunction with the accompanying drawing, in which:

FIG. 1 is a diagrammatic illustration of leveled reading program utilizing a telephone Reading Buddy.

FIG. 2 is a diagrammatic illustration of a web based leveled reading program utilizing voice recognition.

FIG. 3 is a diagrammatic illustration of an iPad application leveled reading program utilizing voice recognition.

FIG. 4 is a diagrammatic illustration of a tablet application leveled reading program utilizing voice recognition.

### MODE(S) FOR CARRYING OUT THE INVENTION

### Detailed Description of Best Mode for Carrying out the Invention

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a telephone system incorporating a reading partner who responds to the reader with specific feedback, a computerized database which maintains records, a series of leveled texts appropriate for the first three years of reading instruction, and a detailed assessment reports that indicate the reader's decoding accuracy percent, fluency rate and comprehension level.

### Operation of Best Mode for Carrying Out the Invention

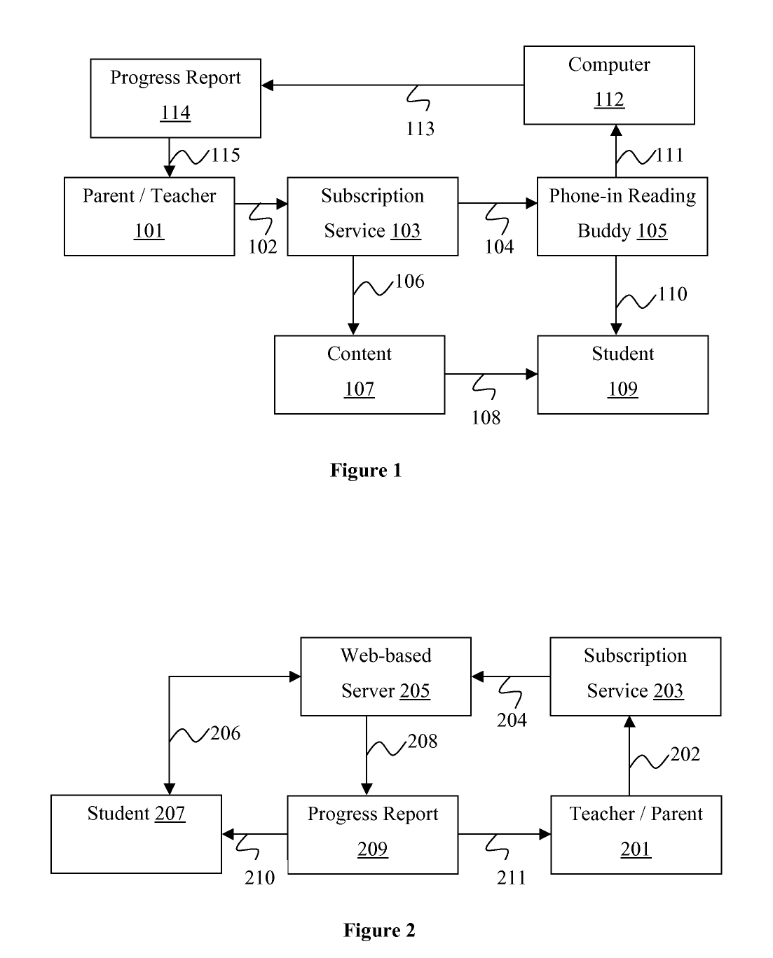

Referring now to the drawings in detail, and initially to FIG. 1, a telephone based reading program. A parent/teacher (101) contacts by phone, email, or mail (102) a subscription service (103) and gives contact information and pays the subscription charge (102). The subscription service notifies (104) the phone-in reading buddy (105) assigned to the account. The phone-in readying buddy (105) initiates contact by telephone (110) to the student (109). The subscription service also notifies (106) the content server (107) that either mails or emails the content (108) to the student. The student (109) and telephone reading buddy (105) interact in reading sessions (110) using the leveled text content, with the student getting corrective feedback from the telephone reading buddy. The telephone reading buddy inputs (111) the progress data including level of text read, accuracy percentage of decoding of text and fluency rate into the computer (112) which records and generates (113) the student progress report (114). That report is transmitted (115) via email or postal mail to the teacher/parent (101).

### Description of Additional Mode for Carrying Out Invention

The making and using of the additional preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to an additional embodiments in a specific context, namely a web based system incorporating a web based server which maintains subscription information, stores the leveled reader content appropriate for the first three years of reading instruction, and provides assessment tasks and records data that indicates the reader's decoding accuracy percent, fluency rate and comprehension level. In addition, there is a voice recognition program on the web server that analyzes the student's reading vocalizations of the leveled texts and provides corrective feedback.

### Operation of Best Mode for Carrying Out the Invention

Referring now to FIG. 2, a web based reading program, the teacher/parent (201) contacts by computer or phone (202) a subscription service (203), providing contact information and making a fee payment. The subscription service accesses (204) web-based server (205) that contains the content and voice recognition software program and establishes a client account. The student (207) interacts (206) with the reading program, with its leveled readers and receives corrective feedback from the voice recognition software in the web-based program (205). At the end of each reading session, the web-based reading program records and delivers (208) via the computer screen a student progress report (209) indicating level(s) of book(s) read, accuracy of decoding and fluency rate. This report (209) is displayed on the computer screen (210) to the student (207) at the end of each session and can be accessed (211) by the teacher/parent (201).

### Description of Additional Mode for Carrying Out Invention

The making and using of the additional preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to additional embodiments in a specific context, namely an application which can be downloaded from the iTunes online store to the iPad, iTouch, iPhone, or Apple mobile device, providing the reader access to leveled reader content appropriate for the first three years of reading instruction, assessment tasks and data that indicates the reader's decoding accuracy percent, fluency rate and comprehension level. In addition, there is a voice recognition program that analyzes student's reading vocalizations of the leveled texts.

### Operation of Best Mode for Carrying Out the Invention

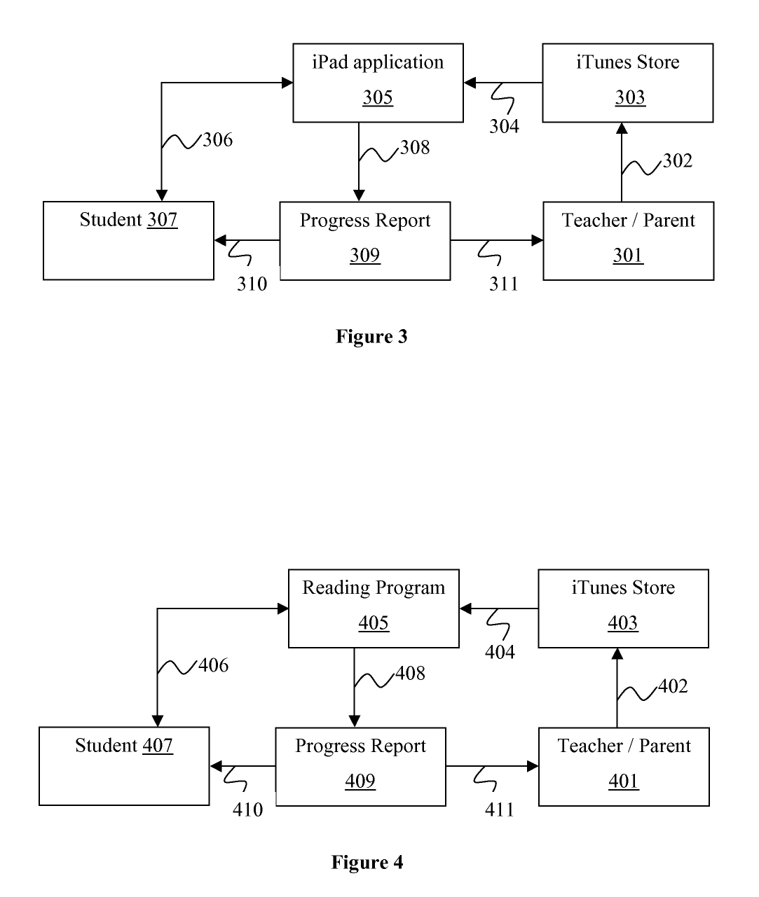

Referring now to FIG. 3, an iPad, iTouch, iPhone, or Apple mobile device application reading program, the teacher/parent (301) contacts by computer (302) the iTunes store (303), providing contact information and makes fee payment (302). The iTunes store downloads (304) the reading program Apple application (305) that contains the content and voice recognition software program and establishes a client account. The student (307) interacts (306) with the reading program, with its leveled readers and receives corrective feedback from the voice recognition software in the iPad, iTouch, iPhone, or Apple mobile device application (305). At the end of each reading session, the App-based reading program records and delivers via the computer screen (310) a student progress report (309) indicating level(s) of book(s) read, accuracy of decoding and fluency rate. This report (309) is displayed on the computer screen (310) to the student (307) at the end of each session and can be accessed (311) by the teacher/parent (301).

### Description of Additional Mode for Carrying Out Invention

The making and using of the additional preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to additional embodiments in a specific context, namely a tablet personal computer application that can be downloaded from a web server via subscription to a tablet, providing the reader access to leveled reader content appropriate for the first three years of reading instruction, assessment tasks and data indicating the reader's decoding accuracy percent, fluency rate and comprehension level. In addition, there is a voice recognition program that analyzes a student's reading vocalizations of the leveled texts.

### Operation of Best Mode for Carrying Out the Invention

Referring now to FIG. 4, a tablet personal computer reading program, teacher/parent (401) contacts by computer (402) the subscription service (403), providing contact information and makes fee payment (402). The subscription service downloads (404) to the tablet personal computer a reading program application (405) that contains the content and voice recognition software program and establishes a client account. The student (407) interacts (406) with the reading program application (405), with its leveled readers and receives corrective feedback from the voice recognition software utilizing the tablet personal computer running the reading program application (405). At the end of each reading session, the reading program application (405) records and delivers via the computer screen a student progress report (409) indicating level(s) of book(s) read, accuracy of decoding and fluency rate. This report (409) is displayed on the computer screen (410) to the student (407) at the end of each session and can be accessed (411) by the teacher/parent (401).

From the foregoing, it will be observed that numerous variations and modifications can be effected without departing from the spirit and scope of the novel concept of the invention. It is to be understood that no limitation with respect to the specific methods and apparatus illustrated herein is intended or should be inferred, but provided to define the best mode of practice that this embodiment defines. It is, of course, intended to cover by the appended claims all such modifications as fall within the scope of the claims.

To date, however, no system has been proposed which can make effective use of a reading program which utilizes voice recognition geared to a beginning reader's initial reading vocalizations, a system of leveled reading texts and a feedback mechanism which provides data on decoding accuracy, fluency rate and comprehension of the text.

From the foregoing, it will be observed that numerous variations and modifications can be effected without departing from the spirit and scope of the novel concept of the invention. It is to be understood that no limitation with respect to the specific methods and apparatus illustrated herein is intended or should be inferred, but provided to define the best mode of practice that this embodiment defines. It is, of course, intended to cover by the appended claims all such modifications as fall within the scope of the claims.

### INDUSTRIAL APPLICABILITY

Accordingly, the industrial applicability of this patent is for the selling of a product that allows an education company to produce a revenue stream from a method of reading instruction, specifically to a mechanism for teaching reading through a leveled reading method using interactive feedback through a telephonic device or a computer device.

### SEQUENCE LISTING

Not applicable

I claim:

1. A learning system for providing students reading practice using stories in a leveled progression comprising:
a. student input means including at least audio input means for delivering student's reading to a speech recognition means;
b. student interface means including at least audio output means for delivering corrective feedback; and
c. student practice means including the practice of reading stories in a leveled progression whereby the corrective feedback based on speech recognition means provides appropriate value to the student in acquiring familiarity with the words and structure of said story.

2. The system of claim 1 further comprising said system incorporating a testing mode which provides a teacher with the level read, percent accuracy of decoding, fluency rate, miscue analysis and a comparison to the grade level standard in accuracy and fluency.

3. The system of claim 1 wherein said student input means is a telephone and said speech recognition means is a teacher or phone-in reading buddy listening to the student by said telephone and said corrective feedback is provided by said teacher or said phone-in reading buddy to said student through said telephone.

4. The system of claim 1 further comprising a parent or teacher that contacts by phone, email, or mail a subscription service and said parent or teacher provides contact information and pays a subscription fee whereby said subscription services notifies a phone-in reading buddy that initiates contact with said student by telephone and said subscription services then notifies a content server which provides stories in a leveled progression by mail or email to said student.

5. The system of claim 4 wherein said student and said phone-in reading buddy interact in a reading session using said stories whereby said phone-in reading buddy provides corrective feedback to said student, and said phone-in reading buddy inputs the progress data including level of text read, accuracy percentage of decoding of text and fluency rate in a computer that records and generates the student progress report that is available to said teacher, said parent, or said student.

6. The system of claim 1 wherein said student input means is a web based reading program and said speech recognition means is a voice recognition software program listening to the student by said audio input means being a computer input means and said corrective feedback is provided by said voice recognition software program to said student through a computer output means.

7. The system of claim 1 further comprising a parent or teacher that contacts by computer or phone a subscription service and said parent or teacher provides contact information and pays a subscription fee and said subscription services accesses a web-based server that initiates contact with said student by email and said subscription services notifies web-based server to provide the content and voice recognition software program to said student.

8. The system of claim 7 wherein said student interacts with said voice recognition software in a reading session using said stories whereby said voice recognition software provides corrective feedback to said student, and said voice recognition program inputs the progress data including level of text read, accuracy percentage of decoding of text and fluency rate using internet connectivity such that records and generates the student progress report that is available to said teacher, said parent, or said student.

9. The system of claim 1 wherein said student input means is an iPad, tablet pc, or Apple mobile device and said speech recognition means is a iPad, tablet pc, or Apple mobile device voice recognition software application listening to the student by said audio input means being a mobile device input means and said corrective feedback is provided by said iPad, tablet pc, or Apple mobile device voice recognition software application to said student through a mobile device output means.

10. The system of claim 1 further comprising a parent or teacher that contacts by computer the iTunes store and said parent or teacher provides contact information and pays a subscription fee and said iTunes store accesses a web-based server that initiates contact with said student by email or online access and said iTunes notifies said web-based server to provide said stories and voice recognition software program to said student.

11. The system of claim 10 wherein said student interacts with said voice recognition application in a reading session using said stories whereby said voice recognition application provides corrective feedback to said student, and said voice recognition application inputs the progress data including level of text read, accuracy percentage of decoding of text and fluency rate through internet connectivity that records and generates the student progress report that is available to said teacher, said parent, or said student.

12. A web-based learning system for providing students reading practice using stories in a leveled progression comprising:
a. student input means including at least computer audio input means for delivering student's reading to a speech recognition means wherein said student input means is a web based reading program and said speech recognition means is a voice recognition software program listening to the student using said computer audio input means;
b. student interface means including at least audio output means for delivering corrective feedback wherein said corrective feedback is provided by said voice recognition software program to said student through a computer output means;
c. testing mode means providing a teacher with the level read, percent accuracy of decoding, fluency rate, miscue analysis and a comparison to the grade level standard in accuracy and fluency; and
d. student practice means including the practice of reading stories in a leveled progression whereby the corrective feedback based on speech recognition means provides appropriate value to the student in acquiring familiarity with the words and structure of said story.

13. The system of claim 12 further comprising a parent or teacher that contacts by computer or phone a subscription service and said parent or teacher provides contact information and pays a subscription fee and said subscription services accesses a web-based server that initiates contact with said student by email and said subscription services notifies web-based server to provide the content and voice recognition software program to said student.

14. The system of claim 13 wherein said student interacts with said voice recognition software in a reading session using said stories whereby said voice recognition software provides corrective feedback to said student, and said voice recognition program inputs the progress data including level of text read, accuracy percentage of decoding of text and fluency rate through internet connectivity that records and generates the student progress report that is available to said teacher, said parent, or said student.

15. The system of claim 12 wherein said student interface means is an iPad, tablet pc, or Apple mobile device and said speech recognition means is a iPad, tablet pc, or Apple mobile device voice recognition software application listening to the student by said audio input means being a mobile device input means and said corrective feedback is provided by said iPad, tablet pc, or Apple mobile device voice recognition software application to said student through a mobile device output means.

16. The system of claim 12 further comprising a parent or teacher that contacts by computer the iTunes store and said parent or teacher provides contact information and pays a subscription fee and said iTunes store accesses a web-based server that initiates contact with said student by email or online access and said iTunes notifies said web-based server to provide said stories and voice recognition software program to said student.

17. The system of claim 16 wherein said student interacts with said voice recognition application in a reading session using said stories whereby said voice recognition application provides corrective feedback to said student, and said voice recognition application inputs the progress data including level of text read, accuracy percentage of decoding of text and fluency rate through internet connectivity that records and generates the student progress report that is available to said teacher, said parent, or said student.

18. A method for a web-based learning system for providing students reading practice using stories in a leveled progression comprising:
a. receiving input from a student's leveled reading using a web based reading program;
b. providing an interpretation of said receiving input using speech recognition;
c. delivering corrective feedback back to said student based on interpretation;
d. providing a teacher with the level read, percent accuracy of decoding, fluency rate, miscue analysis and a comparison to the grade level standard in accuracy and fluency; and
e. providing said student repetition of reading stories in a leveled progression such that said corrective feedback based on said interpretation student provide practice of reading stories in a leveled progression whereby the corrective feedback provides appropriate value to the student in acquiring familiarity with the words and structure of said story.

19. The method of claim 18 wherein said interpretation is a voice recognition software program not located near the student but is accessed across the Internet.

20. The method of claim 18 wherein said providing said student repetition of reading stories consists of a leveled text, leveled structure, and leveled progression in synchronization with said student's level read, percent accuracy of decoding, fluency rate, and miscue analysis and in comparison to the grade level standard in accuracy and fluency.
